(19) United States
(12) Patent Application Publication
(10) Pub. No.: US 2005/0244030 A1
(43) Pub. Date: Nov. 3, 2005

(54) Speaker apparatus

(75) Inventors: Koji Takayama, Tendo-shi (JP); Takahisa Haba, Tendo-shi (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/118,390

(22) Filed: May 2, 2005

(30) Foreign Application Priority Data
Apr. 30, 2004 (JP) P2004-135000

(51) Int. Cl. H04R 25/00

(52) U.S. Cl. 381/404; 381/398

(57) ABSTRACT

A speaker apparatus including a diaphragm; a damper which elastically supports the diaphragm at a damper mount portion; and a frame to which the diaphragm and the damper are attached, wherein the frame has at least one aperture on a back side in a sound emitting direction with respect to the damper mount portion.

### BACKGROUND OF THE INVENTION

1. Field of the Invention

The present invention relates to a technical field of speaker apparatus used in various audio equipments.

2. Related Art

In a conventional technique, as shown in FIG. 4, a speaker apparatus 1 has a magnet 2, a center piece 3 attached to a lower surface of the magnet 2, a yoke 4 attached to an upper surface of the magnet 2 to form a magnetic circuit 5.

A frame 6 is attached to a front surface of the magnetic circuit 5 in a direction of emitting sound. The frame 6 has a damper mount portion 7 which is provided to attach a damper for elastically supporting a vibration unit (not shown) including a voice coil (VC) and a diaphragm (tympanum).

However, in the conventional speaker apparatus 1, dust is apt to intrude from an opening portion 8 which widely opens on the speaker apparatus into a magnetic gap between a center piece and a yoke. If the dust intrudes into the gap when the speaker apparatus is driven, the dust prevents the voice coil from vibrating and the sound quality is deteriorated.

The present invention is provided to solve the above mentioned problem in the conventional technique.

According to a first aspect of the present invention, there is provided a speaker apparatus comprising:
a diaphragm;
a damper which elastically supports the diaphragm at a damper mount portion; and
a frame to which the diaphragm and the damper are attached, wherein
the frame has at least one aperture on a back side in a sound emitting direction with respect to the damper mount portion.

According to a second aspect of the present invention, there is provided a speaker apparatus according to the first aspect, wherein the diameter of the aperture is 1.2 to 1.5 mm.

According to a third aspect of the present invention, there is provided a speaker apparatus according to the first aspect, wherein the aperture is shaped like a circle.

According to a fourth aspect of the present invention, there is provided a speaker apparatus according to the first aspect, wherein the aperture is shaped like a polygon.

According to a fifth aspect of the present invention, there is provided a speaker apparatus according to the first aspect, wherein
the number of the apertures is plural and the apertures are arranged in a peripheral direction of the frame so as to locally keep in line.

### BRIEF DESCRIPTION OF THE DRAWINGS

In the accompanying drawings:

FIG. 1 is a cross-sectional view of a speaker apparatus according to an embodiment of the present invention;

FIG. 2 is a plan view of the speaker apparatus shown in FIG. 1;

FIG. 3 is a plan view of a speaker apparatus according to an embodiment of the present invention; and

FIG. 4 is a plan view of a speaker apparatus according to an embodiment of the present invention.

### DESCRIPTION OF THE PREFERRED EMBODIMENTS

Preferred embodiments of the present invention will be described in conjunction with the figures. Hereinafter, each meaning of the reference numbers in the drawings is as follows:

10: speaker apparatus, 15: voice coil, 16: bobbin, 17: coil bobbin, 18: diaphragm (tympanum), 19: edge portion, 20: frame, 20a: damper mount portion, 21: damper, and 23: aperture.

An embodiment of the present invention will be described in reference of the figures.

### Embodiment 1

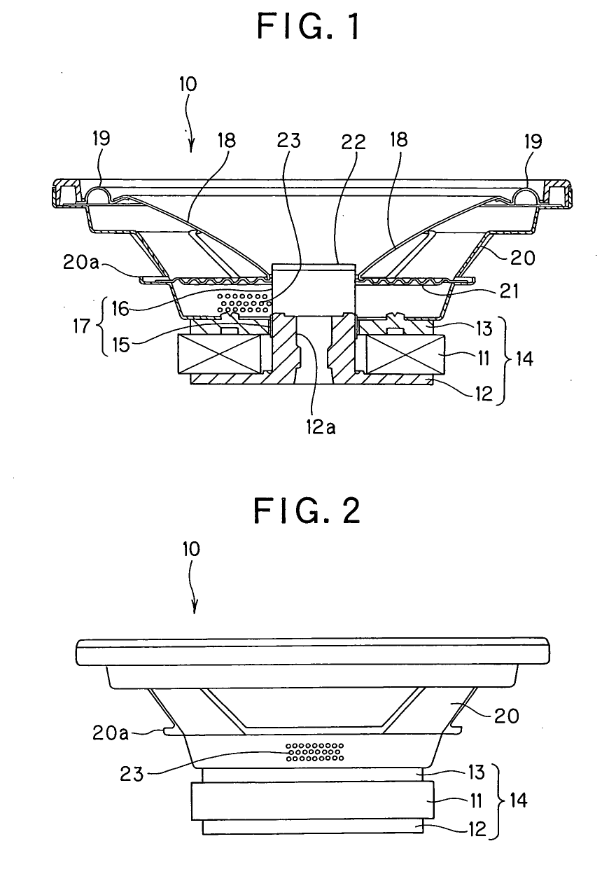

First, the structure of a speaker apparatus according to this embodiment will be described in reference of FIGS. 1 and 2. FIG. 1 is a cross-sectional view of a speaker apparatus according to this embodiment, and FIG. 2 is a plan view of the speaker apparatus shown in FIG. 1.

As shown in FIG. 1, the speaker apparatus 10 includes a magnet 11, a center piece 12 attached to a lower surface of the magnet 11, a yoke 13 attached to an upper surface of the magnet 11 to form a magnetic circuit 14.

The speaker apparatus 10 is made up of a voice coil 15 that is arranged in a magnetic gap between the center piece 12 and the yoke 13, a bobbin 16 for attaching the voice coil 15, a diaphragm 18 attached to the coil bobbin 17 which is made up of the voice coil 15 and the bobbin 16, an edge portion 19 attached to an outer peripheral portion of the diaphragm 18, a frame 20 holding the diaphragm 18 at a predetermined position via the edge portion 19, a damper 21 which is attached to the frame 20 at one end and elastically supports a vibration unit including the voice coil 15 and the diaphragm 18 at the other end, and a center cap 22 arranged in a center of the diaphragm 18.

The magnet 11 is for example formed to be in a disk shape having a hole in a center thereof and for example made from a magnetic material having a high magnetic flux density such as a neodymium magnet.

The center piece 12 is made from a magnetic material of for example iron or an alloy of iron and is attached to a lower surface of the magnet 11. The center piece 12 has a shape that a protrusion 12a is formed in a center thereof. The protrusion 12a is inserted into a hole formed in the center of the magnet 11.

The yoke 13 is made from a magnetic material of for example iron or an alloy of iron, is formed in a disk shape having a hole in a center thereof, and is attached to an upper surface of the magnet 11. A magnetic gap is formed between an inner peripheral surface of the yoke 13 and an outer peripheral surface of the centerpiece 12 at a position opposite to the inner peripheral surface.

The voice coil 15 is for example made from a copper wire and wound around the bobbin 16.

The bobbin 16 is made from for example a craft paper or a heat resistance plastic, wherein one end thereof is fixed to the diaphragm 18 and the voice coil 15 is wound around the other end thereof. The coil bobbin 17 is made up of the voice coil 15 and the bobbin 16.

The diaphragm 18 is formed by laminating a hot-chamber molded synthetic fiber or a chemical fiber on a paper diaphragm through a film.

The edge portion 19 is made from for example by a cloth, an urethane, or a rubber to restore a predetermined position when the diaphragm 18 vibrates.

The center cap 22 is formed by press-molding a thin alloy plate of for example aluminum and prevents dust from intruding into the speaker apparatus 10.

The speaker apparatus 10 according to the present invention corresponds to a speaker apparatus according to the present invention. The voice coil 15 and the diaphragm 18 correspond to a vibration unit according to the present invention. The frame 20 corresponds to a frame according to the present invention.

Meanwhile, in this embodiment, at a part of the frame 20 in the sound emitting direction and on the back surface with respect to the position of attaching the damper for elastically supporting the vibration unit including the voice coil 15 and the diaphragm 18, a plurality of apertures 23 are formed to reduce air resistance generated on the back surface side of the damper mount portion 20a when the vibration is generated and improve linearity of amplitude. The number of the apertures 23 is for example 26.

The plurality of apertures 23 are locally arranged in a peripheral direction of the frame 20 so as to locally keep in line. Each aperture is shaped like a circle having a diameter of 1.2 to 1.5 mm to avoid dust from intruding through the aperture. It is preferable that the local arrangement of the plurality of the apertures 23 in the peripheral directions is to effectively avoid dust from intruding through the apertures.

Next, the effect of the plurality of apertures according to the present embodiment will be described.

Ordinarily, when a large opening is formed in the frame in order to reduce an air resistance which is generated on the back side of the damper mount portion 20a and improve linearity of the amplitude, dust is apt to intrude into a magnetic gap between the center piece 12 and the yoke 13.

Therefore, in the present embodiment, the plurality of apertures 23 are formed in the frame 20 on the back side in the sound emitting direction and on the back surface with respect to the position of attaching the damper for elastically supporting the vibration unit including the voice coil 15 and the diaphragm 18 to thereby obstruct dust from intruding into the magnetic gap between the center piece 12 and the yoke 13.

Accordingly, the number of the parts is not increased and the number of the operation processes are in advance prevented from increasing.

Further, since the plurality of the apertures 23 according to the present embodiment are locally arranged with respect to the peripheral direction of the frame 20 and are formed to be in a circular shape of a diameter of 1.2 to 1.5 mm, it is possible to securely prevent dust from intruding into the magnetic gap between the center piece 12 and the yoke 13.

Various modifications are possible with respect to the apertures. For example, the number of the aperture may be one.

The aperture may be shaped like a polygon other than the circle, wherein the area of each polygonal aperture may be substantially the same as that of the circular aperture.

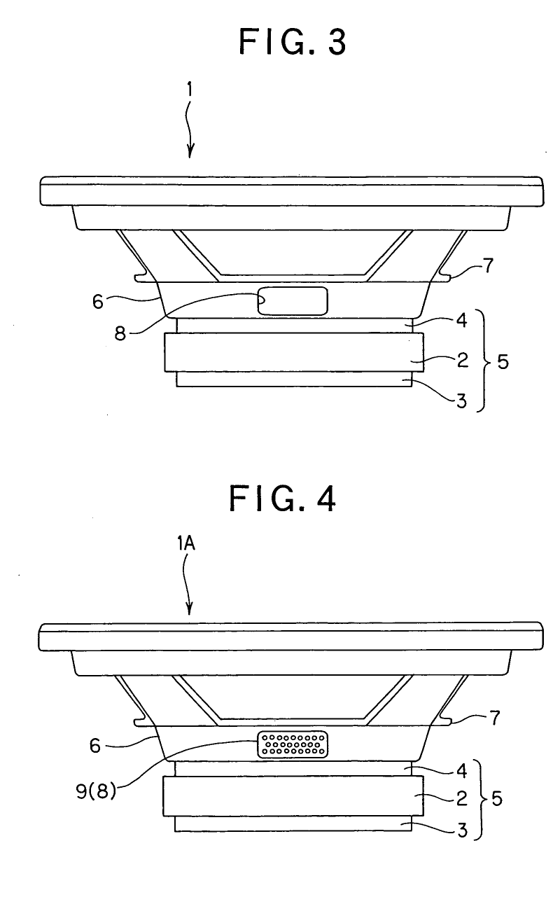

The aperture may be shaped like a single rectangle 8 as shown in FIG. 3.

Further, the single rectangle 8 may have a mesh portion 9 as shown in FIG. 4.

The present invention is not confined to the configurations listed in the foregoing embodiments, but it is easily understood that the person skilled in the art can modify such configurations into various other modes, within the scope of the present invention described in the claims.

The entire disclosures of Japanese Patent Applications No. 2004-135000 filed on Apr. 30, 2004 including the specification, claims, drawings and summary are incorporated herein by reference in its entirety.

1. A speaker apparatus comprising:
a diaphragm;
a damper which elastically supports the diaphragm at a damper mount portion; and
a frame to which the diaphragm and the damper are attached, wherein
the frame has at least one aperture on a back side in a sound emitting direction with respect to the damper mount portion.

2. A speaker apparatus according to claim 1, wherein
the diameter of the aperture is 1.2 to 1.5 mm.

3. A speaker apparatus according to claim 1, wherein
the aperture is shaped like a circle.

4. A speaker apparatus according to claim 1, wherein
the aperture is shaped like a polygon.

5. A speaker apparatus according to claim 1, wherein
the number of the apertures is plural and the apertures are arranged in a peripheral direction of the frame so as to locally keep in line.
